(19) United States
(12) Patent Application Publication
(10) Pub. No.: US 2007/0082185 A1
(43) Pub. Date: Apr. 12, 2007

(54) Multi-layered film

(75) Inventors: Hajime Ikeno, Kawasaki-shi (JP); Mikio Kawase, Kawasaki-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: JAPAN POLYPROPYLENE CORPORATION, Tokyo (JP)

(21) Appl. No.: 11/247,589

(22) Filed: Oct. 12, 2005

(51) Int. Cl. B32B 27/32; B32B 27/08

(52) U.S. Cl. 428/213; 428/516; 428/220

(57) ABSTRACT

To provide a multi-layered film as transparent as that produced by T-die or water-cooled inflation molding, even when produced by air-cooled inflation molding, and excellent in tearing strength, impact strength, heat-sealing capacity at low temperature and interlayer strength.

The multi-layered film comprises a propylene-based resin layer composed of a propylene/α-olefin random copolymer as the major component, which has a melt flow rate (MFR, determined at 230° C.) of 1 to 30 g/10 minutes, melting peak temperature (Tm) of 110 to 165° C. and Mw/Mn ratio of 1.5 to 3.5, and is produced in the presence of a metallocene catalyst, wherein the propylene-based resin layer is laminated, on each side, with a copolymer of ethylene and α-olefin of 3 to 12 carbon atoms, having an MFR (determined at 190° C.) of 0.1 to 20 g/10 minutes and density: 0.860 to 0.925 g/cm³.

### BACKGROUND OF THE INVENTION

1. Field of the Invention

The present invention relates to a multi-layered film, more specifically a multi-layered film high in transparency, and excellent in tearing strength, impact strength, heat-sealing capacity, interlayer strength.

2. Description of the Prior Art

Polypropylene-based resins have been widely used, in particular in food packing areas, because of their high tensile strength, rigidity and transparency, and also of their favorable food hygienic characteristics, e.g., innocuousness and scentlessness. They are generally in the form of film, when used in food packing areas.

The film-making methods include T-die, water-cooled inflation and air-cooled inflation molding, and an appropriate method is selected in consideration of economic efficiency, required film properties and so on.

Of these methods, air-cooled inflation molding is characterized by high operability, resulting from a simpler system it needs and film width easily adjustable by merely controlling blow ratio, and giving highly scentless products because it operates at relatively low temperature. It has been widely applied to polyethylene-based resins but not widely to polypropylene-based resins, because of several disadvantages. For example, it causes bubbles swinging largely when operated at a high speed to prevent stable film-making process and gives products notably oriented to the MD direction and hence deteriorated in longitudinal tearing strength. Moreover, air-cooled inflation may not simply give a transparent film from a propylene-based resin which can be made into a transparent film by T-die or water-cooled inflation molding.

Various inventions have been developed, in particular to solve the transparency-related problems. For example, JP-A-56-84712 discloses a method which uses a resin composition, composed of polypropylene of high molecular weight, containing ethylene at a specific content and having a block copolymer of specific molecular chains. JP-A-56-118825 discloses a method which uses a resin composition composed of polypropylene resin incorporated with an unsaturated carboxylic acid or its modification with polypropylene. JP-A-7-125064 discloses a method which uses syndiotactic polypropylene to realize high transparency. JP-A-8-174665 discloses a method which uses a copolymer of polypropylene and alkenyl silane. However, these methods need a very special resin and cannot improve transparency to a sufficient extent, failing to secure transparency realizable by T-die film or water-cooled inflation molding.

Lamination of a polypropylene-based and polyethylene-based resin films is a common procedure. However, it involves problems, when carried out by coextrusion or the like, resulting from low interlayer strength between these layers, which can easily cause delamination to result in insufficient heat-sealing capacity. Therefore, they are bonded to each other by an adhesive agent or the like, which involves problems, e.g., need for an additional bonding step and increased environmental loads due to use of a solvent.

### SUMMARY OF THE INVENTION

It is an object of the present invention to provide, even by air-cooled inflation molding, a polypropylene film as transparent as that produced by T-die or water-cooled inflation molding, and excellent in tearing strength, impact strength, heat-sealing capacity at low temperature and interlayer strength, in consideration of the above problems.

The inventors of the present invention have found, after having extensively studied to solve the above problems, that a polypropylene film excellent in transparency, tearing strength, impact strength, heat-sealing capacity at low temperature and interlayer strength can be provided when a specific propylene/α-olefin random copolymer and specific ethylene/α-olefin copolymer are laminated and molded even by air-cooled inflation molding, achieving the present invention.

The first aspect of the present invention is a multi-layered film comprising a propylene-based resin layer composed of Component (A) described below as the major component, laminated on each side with an ethylene-based resin layer composed of Component (B) described below:
Component (A): propylene/α-olefin random copolymer, produced in the presence of a metallocene catalyst and having the following characteristics (A1) to (A3),
   (A1) melt flow rate (MFR: 230° C., 21.18 N load): 1 to 30 g/10 minutes,
   (A2) melting peak temperature (Tm), determined by differential scanning calorimetry (DSC): 110 to 165° C., and
   (A3) weight-average molecular weight (Mw)/number-average molecular weight (Mn) ratio (Mw/Mn ratio), determined by gel permeation chromatography (GPC): 1.5 to 3.5,
Component (B): copolymer of ethylene and α-olefin of 3 to 12 carbon atoms, having the following characteristics (B1) and (B2):
   (B1) melt flow rate (MFR: 190° C., 21.18 N load): 0.1 to 20 g/10 minutes, and
   (B2) density: 0.860 to 0.925 g/cm³.

The second aspect of the present invention is the multi-layered film according to the first aspect, wherein the copolymer of ethylene and α-olefin of 3 to 12 carbon atoms as Component (B) is produced in the presence of a metallocene catalyst and has the following characteristics (B3) and (B4):
(B3) α-olefin content: 5 to 40% by mass, and
(B4) Z-average molecular weight (Mz)/number-average molecular weight ratio (Mz/Mn ratio), determined by gel permeation chromatography (GPC): 8.0 or less.

The third aspect of the present invention is the multi-layered film according to the first or second aspect which has a tearing strength of 20 N/mm or more and punching impact strength of 1000 kg·cm/cm or more.

The fourth aspect of the present invention is the multi-layered film according to one of the first to third aspects, wherein the propylene-based resin layer is incorporated with Component (C) described below at 0.1 to 5 parts by mass per 100 parts by mass of Component (A):
Component (C): high-density polyethylene having the following characteristics (C1) and (C2):
   (C1) melt flow rate (MFR: 190° C., 21.18 N load): 10 g/10 minutes or more, and
   (C2) density: 0.94 to 0.98 g/cm³.

The fifth aspect of the present invention is the multi-layered film according to one of the first to fourth aspects, wherein thickness of the propylene-based resin film is 20 to 90% of thickness of the whole multi-layered film.

The sixth aspect of the present invention is the multi-layered film according to one of the first to fifth aspects, wherein thickness of the whole multi-layered film is 10 to 150 μm.

The seventh aspect of the present invention is a multi-layered film produced by air-cooled inflation molding and comprising a propylene-based resin layer composed of Component (A) described below as the major component, laminated on each side with an ethylene-based resin layer composed of Component (B) described below:
Component (A): propylene/α-olefin random copolymer, produced in the presence of a metallocene catalyst and having the following characteristics (A1) to (A3),
   (A1) melt flow rate (MFR: 230° C., 21.18 N load): 1 to 20 g/10 minutes,
   (A2) melting peak temperature (Tm), determined by differential scanning calorimetry (DSC): 110 to 135° C., and
   (A3) weight-average molecular weight (Mw)/number-average molecular weight (Mn) ratio (Mw/Mn ratio), determined by gel permeation chromatography (GPC): 1.5 to 3.5,
Component (B): copolymer of ethylene and α-olefin of 3 to 12 carbon atoms, having the following characteristics (B1) and (B2):
   (B1) melt flow rate (MFR: 190° C., 21.18 N load): 0.1 to 20 g/10 minutes, and
   (B2) density: 0.860 to 0.925 g/cm³.

The eighth aspect of the present invention is the multi-layered film according to the seventh aspect, wherein the copolymer of ethylene and α-olefin of 3 to 12 carbon atoms as Component (B) is produced in the presence of a metallocene catalyst and has the following characteristics (B3) and (B4):
(B3) α-olefin content: 5 to 40% by mass, and
(B4) Z-average molecular weight (Mz)/number-average molecular weight Mn ratio (Mz/Mn ratio), determined by gel permeation chromatography (GPC): 8.0 or less.

The ninth aspect of the present invention is the multi-layered film according to the seventh or eighth aspect which has a tearing strength of 20 N/mm or more and punching impact strength of 1000 kg cm/cm or more.

The tenth aspect of the present invention is the multi-layered film according to one of the seventh to ninth aspects, wherein the propylene-based resin layer is incorporated with Component (C) described below at 0.1 to 5 parts by mass per 100 parts by mass of Component (A):
Component (C): high-density polyethylene having the following characteristics (C1) and (C2):
   (C1) melt flow rate (MFR: 190° C., 21.18 N load): 10 g/10 minutes or more, and
   (C2) density: 0.94 to 0.98 g/cm³.

The 11^{th} aspect of the present invention is the multi-layered film according to one of the seventh to tenth aspects, wherein thickness of the propylene-based resin film is 20 to 90% of thickness of the whole multi-layered film.

The 12^{th} aspect of the present invention is the multi-layered film according to one of the seventh to 11^{th} aspects, wherein thickness of the whole multi-layered film is 10 to 150 μm.

### DEATAILED DESCRIPTION OF THE INVENTION

The multi-layered film of the present invention comprises a propylene-based resin layer composed of Component (A) as the major component, laminated on each side with an ethylene-based resin layer composed of Component (B). The components of these layers, film-molding method and so on are described in detail below.

1. Propylene-Based Resin Layer

The propylene-based resin layer for the multi-layered film of the present invention is composed of Component (A), described below, and a nucleating agent incorporated as required.

(1) Component (A)

Component (A) for the multi-layered film of the present invention is a propylene/α-olefin random copolymer produced by polymerization in the presence of a metallocene catalyst and having the following characteristics (A1) to (A3). The film tends to deteriorate in transparency and interlayer strength to result in deteriorated heat-sealing capacity when the propylene/α-olefin random copolymer is laminated with an ethylene/α-olefin copolymer, unless it is produced by polymerization in the presence of a metallocene catalyst. The constituent monomers for the copolymer, polymerization method and copolymer characteristics are described in this order.

(i) Constituent Monomers

The propylene/α-olefin random copolymer for the present invention is composed of a propylene-derived unit as the major component.

The α-olefin as the comonomer is preferably ethylene or an α-olefin of 4 to 18 carbon atoms. More specifically, the α-olefins useful for the present invention include ethylene, 1-butene, 1-pentene, 1-hexene, 1-octene, 1-heptene and 4-methyl-pentene-1,4-methyl-hexene-1,4,4-dimethylpentene-1. They may be used either individually or in combination.

Specific examples of the propylene/α-olefin random copolymers include propylene/ethylene, propylene/1-butene, propylene/1-hexene, propylene/ethylene/1-octene and propylene/ethylene/1-butene random copolymers.

The propylene/α-olefin random copolymer contains the propylene unit at 88 to 99.9% by mass, preferably 91 to 99%, more preferably 92 to 98.5%, and the α-olefin unit at 0.5 to 12%, preferably 1 to 10%, more preferably 1.5 to 5%. At a propylene unit content below the above range, the resulting film may have a deteriorated rigidity and insufficient blocking resistance. At a propylene unit content beyond the above range, on the other hand, the resulting film may have deteriorated heat-sealing capacity at low temperature. The propylene and α-olefin unit contents are determined by ¹³C-NMR under the following conditions.
Analyzer: JEOL, GSX270
Concentration: 300 mg/2 mL
Solvent: Orthodichlorobenzene

(ii) Polymerization Catalyst and Method

The propylene/α-olefin random copolymer for the present invention can be easily produced in the presence of a metallocene catalyst. The catalyst comprises (1) a transition metal compound of Group 4 in the periodic table containing a ligand of cyclopentadienyl structure (the so-called metallocene compound), (2) promoter which can react with the metallocene compound to activate it to a stable ionic condition and, as required (3) organoaluminum compound. Any known metallocene catalyst may be used for the present invention. The metallocene compound is preferably a crosslinked one which can polymerize propylene to have stereoregularity. It is more preferably a crosslinked one which can polymerize propylene to have isoregularity.

(1) The metallocene compounds are disclosed in JP-A 60-35007, 61-130314, 63-295607, 1-275609, 2-41303, 2-131488, 2-76887, 3-163088, 4-300887, 4-211694, 5-43616, 5-209013, 6-239914, 7-504934 and 8-85708.

More specifically, they include zirconium compounds, e.g., methylenebis(2-methylindenyl) zirconium dichloride, ethylenebis(2-methylindenyl) zirconium dichloride, ethylene-1,2-(4-phenylindenyl)(2-methyl-4-phenyl-4H-azulenyl) zirconium dichloride, isopropylidene(cyclopentadienyl)(fluorenyl) zirconium dichloride, isopropylidene(4-methylcyclopentadienyl)(3-t-butylindenyl) zirconium dichloride, dimethylsilylene(2-methyl-4-t-butyl-cyclopentadienyl)(3′-t-butyl- 5′-methyl-cyclopentadienyl) zirconium dichloride, dimethylsilylenebis(indenyl) zirconium dichloride, dimethylsilylenebis(4,5,6,7-tetrahydroindenyl) zirconium dichloride, dimethylsilylenebis[1-(2-methyl-4-phenylindenyl)] zirconium dichloride, dimethylsilylenebis[1-(2-ethyl-4-phenylindenyl)] zirconium dichloride, dimethylsilylenebis[4-(1-phenyl-3-methylindenyl)] zirconium dichloride, dimethylsilylene(fluorenyl)-t-butylamido zirconium dichloride, methylphenylsilylenebis[1-(2-methyl-4, (1-naphtyl)-indenyl)] zirconium dichloride, dimethylsilylenebis [1-(2-methyl-4,5-benzoindenyl)] zirconium dichloride, dimethylsilylenebis [1-(2-methyl-4-phenyl-4H-azulenyl)] zirconium dichloride, dimethylsilylenebis [1-(2-ethyl-4-(4-chlorophenyl) -4H-azulenyl)] zirconium dichloride, dimethylsilylenebis[1-(2-ethyl-4-naphtyl-4H-azulenyl)] zirconium dichloride, diphenylsilylenebis[1-(2-methyl-4-(4-chlorophenyl)-4H-azulenyl)] zirconium dichloride, dimethylsilylenebis [1-(2-ethyl-4-(3-fluorobiphenylyl)-4H-azulenyl)] zirconium dichloride, dimethylgermylenebis[1-(2-ethyl-4-(4-chlorophenyl)-4H-azulenyl)] zirconium dichloride, and dimethylgermylenebis[1-(2-ethyl-4-phenylindenyl)] zirconium dichloride. These compounds whose zirconium is substituted by titanium or hafnium can be similarly useful for the present invention. A mixture of zirconium compound with hafnium compound or the like may be also useful depending on circumstances. Chloride in the above compounds may be substituted by another halogen compound; hydrocarbon group, e.g., methyl, isobutyl or benzyl group; amide group, e.g., dimethylamide or diethylamide group; alkoxide group, e.g., methoxy or phenoxy group; hydride group; or the like.

Of these, a metallocene compound whose indenyl or azulenyl group is crosslinked with silicon or germyl group is more preferable.

The metallocene catalyst may be supported by an inorganic or organic carrier. The carrier is preferably of a porous inorganic or organic compound. More specifically, these compounds include inorganic compounds, e.g., ion-exchangeable silicate of layered structure, zeolite, SiO₂, Al₂O₃, silica-alumina, MgO, ZrO₂, TiO₂, B₂O₃, CaO, ZnO, BaO, ThO₂; organic compounds, e.g., porous polyolefin, styrene/divinyl benzene copolymer and olefin/acrylic acid copolymer; and a mixture thereof.

(2) The promoters which can react with the metallocene compound to activate it to a stable ionic condition include an organoaluminumoxy compound, e.g., aluminoxane compound; ion-exchangeable silicate of layered structure, Lewis acid, boron-containing compound, ionic compound and fluorine-containing organic compound.

(3) The organoaluminum compounds include trialkyl aluminum, e.g., triethyl aluminum, triusopropyl aluminum and triusobutyl aluminum, dialkyl aluminum halide, alkyl aluminum sesquihalide, alkyl aluminum dihalide, alkyl aluminum hydride and organoaluminum alkoxide.

The polymerization methods include slurry method which uses an inert solvent, solution method, vapor-phase method which uses substantially no solvent and bulk method which uses a polymerization monomer as a solvent, all carried out in the presence of a metallocene catalyst. The desirable propylene/α-olefin copolymer for the present invention can be produced by adjusting polymerization temperature and comonomer content to adequately control molecular weight and crystallinity distributions of the copolymer.

The propylene/α-olefin random copolymer may be adequately selected from commercial metallocene-based polypropylene products, e.g., Japan Polypropylene's WINTEC.

(iii) Characteristics

(A1) Melt flow rate (MFR: 230° C., 21.18 N load)

The propylene/α-olefin random copolymer for the present invention has an MFR value (determined at 230° C. and a load of 21.18 N) of 1 to 30 g/10 minutes, preferably 1 to 20 g/10 minutes, more preferably 4 to 15 g/10 minutes. An MFR level outside of the above range is not desirable. At a level below the above range, extrudability of the copolymer may deteriorate making it difficult to secure good productivity and, at the same time, the resulting film may not have sufficient transparency. At a level beyond the above range, on the other hand, the resulting film may have a deteriorated strength and tube stability in the air-cooled inflation molding process may also deteriorate. Polymer MFR can be adjusted by adequately controlling polymerization temperature, catalyst quantity, supply rate of hydrogen as a molecular weight adjustor or the like.

MFR is determined in accordance with JIS K-6921-2: 1997 Appendix (230° C., 21.18 N load).

(A2) Melting Peak Temperature (Tm)

The propylene/α-olefin random copolymer for the present invention has a melting peak temperature (Tm) of 110 to 165° C., determined by differential scanning calorimetry (DSC), preferably 110 to 145° C., more preferably 110 to 135° C. At a Tm level below the above range, the resulting film may have a deteriorated rigidity and insufficient blocking resistance. At a Tm level beyond the above range, on the other hand, the resulting film may have deteriorated heat-sealing capacity at low temperature.

The Tm level may be affected by content and type of the α-olefin used and regioregularity of the propylene unit. When ethylene is used as the α-olefin, its content will be about 0.1 to 5% by mass. When 1-butene is used as the α-olefin, its content will be about 0.1 to 15% by mass.

Melting peak temperature (Tm) can be adequately adjusted by controlling type and content of the α-olefin as the comonomer.

It is determined by a DSC analyzer (Seiko), where 5.0 mg of the sample was kept at 200° C. for 5 minutes, cooled at 10° C./minute to be crystallized to −40° C., at which it was held for 1 minute, and then heated at 10° C./minute to be molten, to determine its melting peak temperature (Tm).

(A3) Weight-Average Molecular Weight (Mw)/Number-Average Molecular Weight (Mn)

The propylene/α-olefin random copolymer for the present invention has a weight-average molecular weight (Mw)/number-average molecular weight (Mn) ratio (Mw/Mn ratio) of 1.5 to 3.5, preferably 1.8 to 3.3, more preferably 2.0 to 3.0. An Mw/Mn ratio outside of the above range is not desirable. At a ratio beyond the above range, the resulting film may have deteriorated transparency. At a ratio below the above range, on the other hand, the resulting copolymer may have deteriorated processability, due to increased extrusion load and shark skin tending to evolve.

One of the methods to adjust the Mw/Mn ratio in the above range is to select an adequate metallocene catalyst.

The Mw/Mn ratio is determined by gel permeation chromatography (GPC) under the following conditions:
Analyzer: GPC 150C (Waters)
Detector: 1A infrared spectrophotometer (MIRAN, measurement wavelength: 3.42 μm)
Column: AD806M/S (Showa Denko), 3 columns used, where the column was calibrated with 0.5 mg/mL solutions of monodisperse polystyrene (Tosoh, A500, A2500, F1, F2, F4, F10, F20, F40 and F288) samples, and the relationship between the eluted volume and logarithm of molecular weight was approximated by a quadratic formula. The sample molecular weight was found as that of polypropylene using viscosity formulae of polystyrene and polypropylene, where coefficient α: 0.723 and log K: −3.967 for the polystyrene viscosity formula, and coefficient α: 0.707 and log K: −3.616 for the polypropylene viscosity formula.
Measurement temperature: 140° C.
Concentration: 20 mg/10 mL
Quantity injected: 0.2 mL
Solvent: Orthodichlorobenzene
Flow rate: 1.0 mL/minute

(2) Nucleating Agent

The component which constitutes the propylene-based resin layer for the multi-layered film of the present invention can be composed of Component (A) incorporated with a nucleating agent. Incorporation of a nucleating agent is preferable, viewed from transparency of the resin layer.

The nucleating agent to be incorporated in Component (A) is not limited, so long as it accelerates the crystal nucleus formation process for the propylene/α-olefin random copolymer. A polypropylene crystallization process generally comprises the crystal nucleus formation and crystal nucleus growth steps. The crystal nucleus formation rate is affected by parameters, e.g., temperature relative to crystallization temperature and orientation of the molecular chain. In particular, uneven crystal nucleus formation rate can notably increases in the presence of a substance which has an effect of accelerating orientation of adsorbed molecular chains and the like.

Specific examples of the nucleating agents useful for the present invention include dibenzylidene sorbitol and a derivative thereof, organophosphoric acid and metallic salt thereof, aromatic sulfonic acid and metallic salt thereof, organocarboxylic acid and metallic salt thereof, partial metallic salt of rosin acid, finely powdered inorganic material, e.g., talc, imide, amide, quinacridonequinone, crystallizable high-molecular-weight compound, e.g., high-density polyethylene, and mixture thereof. Of these, metallic salt of organophosphoric acid, metallic salt of organocarboxylic acid and high-density polyethylene are suitable for packing foods, because of their scentlessness.

A film of resin containing a dibenzylidene sorbitol derivative is suitable for packing toys, utensils and the like, particularly because of its high transparency and display effect. Specific examples of dibenzylidene sorbitol derivatives include 1,3:2,4-bis(o-3,4-dimethylbenzylidene) sorbitol, 1,3:2,4-bis(o-2,4-dimethylbenzylidene) sorbitol, 1,3:2,4-bis(o-4-ethylbenzylidene) sorbitol, 1,3:2,4-bis(o-4-chlorobenzylidene) sorbitol and 1,3:2,4-dinzylidene sorbitol.

A film of resin containing a metallic salt of organophosphoric acid is suitable for packing foods, particularly because of its scentlessness and hygienic characteristics. Specific examples of metallic salts of organophosphoric acid include the compounds represented by the general formula (I). 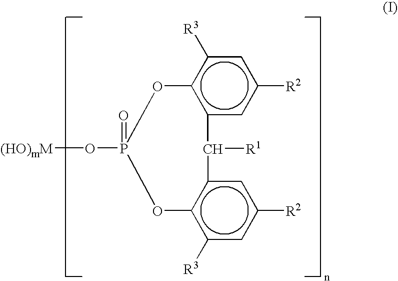
(wherein, R¹ is hydrogen atom or an alkyl group of 1 to 4 carbon atoms; R² and R³ are each hydrogen atom, an alkyl group of 1 to 12 carbon atoms, cycloalkyl, aryl or aralkyl group; M is an alkali metal, alkali-earth metal, aluminum or zinc; “m” is 0 and “n” is 1 when M is an alkali metal, “n” is 1 or 2 when M is a divalent metal with “m” being 1 when “n” is 1 and 0 when “n” is 2, and “m” is 1 and “n” is 2 when M is aluminum).

A film of resin containing a metallic salt of benzoic acid is suitable as a common packing material, particularly because of its economic efficiency and inexpensiveness. Specific examples of metallic salts of benzoic acid include hydroxyl-di (t-butylbenzoic acid aluminum).

A film of resin containing high-density polyethylene is moldable at a high rate and suitable for packing widely varying products, particularly because of its stable processability. Component (C) which has the following characteristics (C1) and (C2) is preferable as a component for high-density polyethylene.

(C1) Melt Flow Rate (MFR: 190° C., 21.18 N load)

The high-density polyethylene for the present invention has an MFR value (determined at 190° C. and a load of 21.18 N) of 10 g/10 minutes or more, preferably 10 to 3000 g/10 minutes. At an MFR below 10 g/10 minutes, the resulting dispersed polyethylene may not have a sufficiently small diameter, which can lead to deteriorated transparency of the polyethylene due to irregularities caused by the dispersed particles on the surface. For the high-density polyethylene to be finely dispersed, it preferably has a higher melt flow rate than the propylene/α-olefin random copolymer.

MFR is determined in accordance with JIS K-6922-2: 1997 Appendix (190° C., 21.18 N load).

(C2) Density

The high-density polyethylene for the present invention has a density of 0.94 to 0.98 g/cm³, preferably 0.95 to 0.98 g/cm³, more preferably 0.96 to 0.98 g/cm³. At a density below 0.94 g/cm³, the effect of improving film transparency may be insufficient. On the other hand, it is difficult to produce polyethylene having a density above 0.98 g/cm³.

High-density polyethylene density is determined in accordance with JIS K-6922-2: 1997 Appendix (23° C.).

Production of high-density polyethylene as the nucleating agent for the present invention is not limited with respect to polymerization method and catalyst, so long as it can secure the objective properties for the agent. However, polyethylene produced by a medium-pressure process is suitable.

The polymerization catalysts useful for the present invention include Ziegler catalyst (a combination of halogen-containing titanium compound and organoaluminum compound, which may be supported or not supported by a carrier), and Kaminsky catalyst (a combination of metallocene compound and organoaluminum compound, in particular aluminoxane, which may be supported or not supported by a carrier).

Ziegler catalyst can be produced by a common polymerization method in the presence of a catalyst which is a combination of a solid catalyst component of magnesium halide, titanium halide or electron donor compound and organoaluminum compound.

Polyethylene shape is not limited. It may be in the form of pellets, powder or wax.

A nucleating agent, when used for the propylene-based resin layer, is incorporated at 0.01 to 5 parts by mass per 100 parts by mass of Component (A). The preferable content range varies depending on type of the agent. In the case of sorbitol derivative, phosphate or benzoate, it is preferably incorporated at 0.01 to 3 parts by mass per 100 parts by mass of Component (A), more preferably 0.01 to 1 part, particularly preferably 0.01 to 0.5 parts. In the case of high-density polyethylene (Component (C)), it is preferably incorporated at 0.1 to 5 parts by mass per 100 parts by mass of Component (A), more preferably 0.5 to 3 parts. At a Component (C) content below 0.01 parts by mass, the effect of improving film transparency may be insufficient. A content above 5 parts by mass, on the other hand, may cause problems, e.g., deteriorated film transparency resulting from polyethylene forming a continuous layer in the film, and agglomeration of Component (C) to cause irregularities.

(3) Other Constituent Components

Any additional component may be optionally incorporated in the propylene-based resin layer for the present invention within limits not significantly harmful to the effect of the present invention. These optional components include additives which have been commonly incorporated in polyolefin resin materials, e.g., antioxidant, transparency improver, lubricant, antiblocking agent, antistatic agent, anticlouding agent, neutralizer, metal passivator, colorant, dispersant, peroxide, filler and fluorescent brightening agent.

Other components which can be also incorporated within limits not significantly harmful to the effect of the present invention include low-density polyethylene produced by high-pressure radical polymerization, linear, low-density polyethylene, ethylene/α-olefin copolymer, isotactic polypropylene, propylene/α-olefin block copolymer and olefin-based elastomer.

More specifically, the commercial products of these compounds include ethylene/α-olefin copolymers, e.g., Japan Polyethylene's Kernel Series and NOVATEC LL Series; olefin-based elastomers, e.g., Mitsui Chemicals' TAFMER P Series and A Series, and JSR's EP Series and EBM Series; and polypropylene/α-olefin block copolymers, e.g., Japan Polypropylene's NOVATEC PP Series and NEWCON Series.

(4) Preparation of Resin Composition

The composition mainly composed of Component (A) for the propylene-based resin layer can be produced by incorporating a nucleating agent or one or more additional components in Component (A) as the essential component, where these components are usually treated by melting/kneading.

The melting/kneading is carried out by a kneader, e.g., one- or two-axle extruder, Banbury mixer, kneader blender, Brabender Plastograph, small-size batch mixer, continuous mixer or mixing roll to treat each component in the form of powder, pellets or the like, normally at 180 to 270° C. A combination of two or more machines described above may be used.

An additional component can be incorporated directly, or its master batch of high concentration is prepared beforehand and incorporated during the molding process.

2. Ethylene-Based Resin Layer

The ethylene-based resin layer for the multi-layered film of the present invention is composed of an ethylene/α-olefin copolymer as Component (B), where the α-olefin has 3 to 12 carbon atoms. It has the following characteristics (B1) and (B2), produced by polymerization preferably in the presence of a metallocene catalyst, and also has the following characteristics (B3) and (B4). The constituent monomers for the copolymer as Component (B), polymerization method and copolymer characteristics are described in this order.

(i) Constituent Monomers

The ethylene/α-olefin copolymer for the present invention is composed of an ethylene-derived unit as the major component.

The α-olefin as the comonomer is preferably an α-olefin of 3 to 12 carbon atoms. More specifically, the α-olefins useful for the present invention include propylene, 1-butene, 1-pentene, 1-hexene, 1-octene, 1-heptene and 4-methyl-pentene-1,4-methyl-hexene-1,4,4-dimethylpentene-1. Specific examples of the ethylene/α-olefin copolymers include ethylene/propylene, ethylene/1-butene, ethylene/1-hexene, ethylene/1-octene and ethylene/4-methyl-pentene-1copolymers. These α-olefins may be used either individually or in combination. The terpolymers, when produced by combining two or more species of α-olefins, include ethylene/propylene/hexane, ethylene/butene/hexane, ethylene/propylene/octane, ethylene/butane/octane terpolymers.

(ii) Polymerization Catalyst and Method

The ethylene/α-olefin copolymer for the present invention can be produced in the presence of a Ziegler catalyst, vanadium catalyst and preferably metallocene catalyst. The useful polymerization methods include high-pressure ion, vapor-phase, solution and slurry polymerization methods.

(iii) Characteristics

(B1) Melt Flow Rate (MFR: 190° C., 21.18 N Load)

The ethylene/α-olefin copolymer for the present invention has an MFR value (determined at 190° C. and a load of 21.18 N) of 0.1 to 20 g/10 minutes, preferably 0.5 to 10 g/10 minutes, more preferably 1.0 to 5 g/10 minutes. At a level below 0.1 g/10 minutes, resin pressure increases to deteriorate copolymer moldability. At a level above 20 g/10 minutes, bubbles become unstable also to deteriorate copolymer moldability.

MFR is determined in accordance with JIS K-6921-2: 1997 Appendix (190° C., 21.18 N load).

(B2) Density

The ethylene/α-olefin copolymer for the present invention has a density of 0.860 to 0.925 g/cm³, preferably 0.870 to 0.920 g/cm³, more preferably 0.880 to 0.915 g/cm³. A density level outside of the above range is not desirable. At a density below 0.860 g/cm³, the resulting film may become sticky. At a density above 0.925 g/cm³, on the other hand, the resulting film may have an insufficient strength.

Density is determined in accordance with JIS K-6922-2 in the case of low-density polyethylene: 1997 Appendix (23° C.).

(B3) Content of the α-Olefin

The ethylene/α-olefin copolymer for the present invention preferably contains the α-olefin at 5 to 40% by mass, more preferably 7 to 35%, still more preferably 9 to 30%. At an α-olefin content below the above range, the resulting film may have a deteriorated impact strength and insufficient heat-sealing capacity at low temperature. At a content beyond the above range, on the other hand, the resulting film may have deteriorated blocking resistance. The α-olefin content is determined by ¹³C-NMR under the following conditions.
Analyzer: JEOL, GSX270
Concentration: 300 mg/2 mL
Solvent: Orthodichlorobenzene

(B4) Z-Average Molecular Weight (Mz)/Number-Average Molecular Weight (Mn) Ratio (Mz/Mn Ratio)

The ethylene/α-olefin copolymer for the present invention preferably has a Z-average molecular weight (Mz)/number-average molecular weight (Mn) ratio (Mz/Mn ratio) of 8.0 or less, determined by gel permeation chromatography (GPC), more preferably 5.0 or less. At a ratio above 8.0, the resulting film may have deteriorated transparency.

One of the methods to adjust the Mz/Mn ratio in the above range is to select an adequate metallocene catalyst.

The Mz/Mn ratio is determined by gel permeation chromatography (GPC) under the following conditions:
Analyzer: GPC 150 C (Waters)
Detector: 1A infrared spectrophotometer (MIRAN, measurement wavelength: 3.42 μm)
Column: AD806M/S (Showa Denko), 3 columns used, where the column was calibrated with 0.5 mg/mL solutions of monodisperse polystyrene (Tosoh, A500, A2500, F1, F2, F4, F10, F20, F40 and F288) samples, and the relationship between the eluted volume and logarithm of molecular weight was approximated by a quadratic formula. The sample molecular weight was found as that of polyethylene using viscosity formulae of polystyrene and polyethylene, where coefficient α: 0.723 and log K: −3.967 for the polystyrene viscosity formula, and coefficient α: 0.733 and log K: −3.407 for the polyethylene viscosity formula.
Measurement temperature: 140° C.
Concentration: 20 mg/10 mL
Quantity injected: 0.2 mL
Solvent: Orthodichlorobenzene
Flow rate: 1.0 mL/minute

The Mz level significantly contributes to average molecular-weight of the high-molecular-weight component, and presence of the high-molecular-weight component can be confirmed more easily with the Mz/Mn ratio than with the Mw/Mn ratio, accordingly. The film has deteriorated transparency when the high-molecular-weight component is present excessively. Therefore, the Mz/Mn ratio is preferably kept as low as possible.

Any additional component may be optionally incorporated in the ethylene-based resin layer for the present invention within limits not significantly harmful to the effect of the present invention. These optional components include additives which have been commonly incorporated in polyolefin resin materials, e.g., antioxidant, crystal nucleating agent, transparency improver, lubricant, antiblocking agent, antistatic agent, anticlouding agent, neutralizer, metal passivator, colorant, dispersant, peroxide, filler and fluorescent brightening agent.

Other components which can be also incorporated within limits not significantly harmful to the effect of the present invention include low-density polyethylene produced by high-pressure radical polymerization, linear, low-density polyethylene, ethylene/α-olefin copolymer, isotactic polypropylene, propylene/α-olefin block copolymer and olefin-based elastomer.

More specifically, the commercial products of these compounds include ethylene/α-olefin copolymers, e.g., Japan Polyethylene's Kernel Series and NOVATEC LL Series; olefin-based elastomers, e.g., Mitsui Chemicals' TAFMER P Series and A Series, and JSR's EP Series and EBM Series; and polypropylene/α-olefin block copolymers, e.g., Japan Polypropylene's NOVATEC PP Series and NEWCON Series.

(iv) Preparation of Resin Composition

The composition composed of Component (B) for the ethylene-based resin layer can be produced by incorporating a nucleating agent or one or more additional components in Component (B) as the essential component, where these components are treated by melting/kneading.

The melting/kneading is carried out by a kneader, e.g., one- or two-axle extruder, Banbury mixer, kneader blender, Brabender Plastograph, small-size batch mixer, continuous mixer or mixing roll to treat each component in the form of powder, pellets or the like, normally at 180 to 270° C. A combination of two or more machines described above may be used.

An additional component can be incorporated directly, or its master batch of high concentration is prepared beforehand and incorporated during the molding process.

3. Multi-Layered Film

The multi-layered film of the present invention comprises a polypropylene-based resin layer composed of Component (A) as an intermediate layer which is laminated with an ethylene-based layer composed of Component (B) on each side.

The multi-layered film may have a 3-layered structure of two layer types with a layer of Component (A) laminated with a layer of Component (B) of the same type on each side, or 3-layered structure of three layer types with a layer of Component (A) laminated with a layer of Component (B) on one side and another layer of Component (B) of different type on the other side.

The multi-layered film of the present invention can be produced by melting/coextrusion which laminates a polypropylene-based resin as Component (A) and ethylene-based resin as Component (B). The melting/coextrusion method may be selected from known ones. The methods include the so-called T-die method; another method in which a molten resin extruded into a film or sheet shape is cooled/solidified while being continuously pressed by a pair of rotating rolls of smooth surface to improve surface smoothness of the laminate; still another method in which it is cooled/solidified by one or more belts of smooth surface instead of rolls; still another method in which a molten resin once solidified into a planar shape without paying consideration of surface smoothness is heated again and then pressed by rolls or belt(s) of smooth surface to eventually have the sheet of smooth surface; and still another method in which a molten resin is extruded into a cylindrical shape is cooled/solidified by water or air flowing around the cylinder.

The multi-layered film of the present invention can be surface treated with corona discharge, flame, plasma or the like by a method normally followed on a commercial scale for various purposes, e.g., to improve printability, facilitate lamination, improve characteristics related to treatability for vacuum evaporation, or facilitate transfer of an antistatic agent or the like over the surface.

Moreover, the multi-layered film of the present invention can be suitably used as at least one layer of a composite film comprising another film (e.g., biaxially drawn polypropylene film, drawn or undrawn nylon film, drawn ethyl polyterephthalate film or aluminum foil) produced by dry lamination, extrusion lamination or the like.

The multi-layered film of the present invention preferably has a tearing strength of 20 N/mm or more, more preferably 40 N/mm or more. The product having a tearing strength below 20 N/mm is not desirable, because it may be easily broken and is difficult to hold contents safely. Its punching impact strength is preferably 1000 kg·cm/cm or more, more preferably 1400 kg·cm/cm or more. The product having a punching impact strength below 1000 kg·cm/cm is not desirable, because it may be easily broken and is difficult to hold contents safely.

For the present invention, film tearing strength is determined in accordance with JIS K-7128 (1991), and punching impact strength by a tester in accordance with JIS P-8134, where the tester is equipped with a metallic hemisphere (diameter: 25.4 Φmm) having a through-hole with mirror-glossy surface.

The multi-layered film of the present invention preferably has a thickness of 10 to 150 μm, because the film having a thickness in the above range can be stably produced.

4. Multi-Layered Film Produced by Air-Cooled Inflation Molding

The multi-layered film of the present invention is produced by air-cooled inflation molding with a plurality of extruders, each provided with a coextrusion, multi-layered, annular die produced.

One of the preferred embodiments of the air-cooled inflation molding method melts and extrudes the resin for the propylene-based resin layer and that for the ethylene-based resin layer by a plurality of extruders, each provided with a coextrusion, multi-layered, annular die into tubes, sprays air supplied by a blower or the like from an air-cooling ring onto these tubes to cool/solidify them, folds them by a pinch roll to which they are guided by a guiding plate, and recovers them by a withdrawing machine. Any special device is not needed for the molding method, and the molder, cooling ring, blower, guiding plate, pinch roll and film withdrawing machine can be those widely available commercially. The molding conditions for the present invention are not limited, so long as the resulting film has the required characteristics. However, the preferable conditions are molding temperature: 170 to 250° C., more preferably 170 to 200° C., and molding rate: 5 to 50 m/minute, more preferably 10 to 40 m/minute.

5. Applicable Areas

The multi-layered film of the present invention is excellent in heat-sealing capacity, high in transparency, high in interlayer strength between the layer composed of Component (A) and that composed of Component (B) to exhibit a high heat-sealing strength, and can be produced at a low cost. As such, it can be used as a packing material for various products, in particular foods, clothing, medicines, utensils and miscellaneous goods, among others.

Specific examples of the packing materials for which the multi-layered film of the present invention is used include those for holding/sealing various products after being processed into the composite film described earlier and then into a bag or cylindrical shape. More specifically, the composite film can be processed by a known method, e.g., heat sealing, impulse sealing, melt sealing, ultrasonic sealing or adhesion with the aid of an adhesive agent, into a known bag, case or the like represented by pillow bag, three-side-sealed bag, standing pouch, spout pouch or the like.

Printing one layer of a composite film is a common procedure for decorative purposes. This also applies to the multi-layered film of the present invention. Products which can be sealed in the bag, case or the like comprising the multi-layered film of the present invention are not limited. Various products for various purposes in the form of solid, semisolid or liquid are generally sealed by a known method, e.g., heat sealing, impulse sealing, melt sealing, ultrasonic sealing or adhesion with the aid of an adhesive agent. Sealed products may be treated, as required, by heat for sterilization. The bag, case or the like may be provided with a zipper to seal products again, after it is opened.

The multi-layered film of the present invention, produced by air-cooled inflation molding, is more clearly transparent without showing whiteness than a film produced by a conventional air-cooled inflation method, and has very high product value as a packing material. The applicable areas are not limited, and the film can be used for packing foods, clothing, medicines, utensils and miscellaneous goods, among others.

### EXAMPLES

The present invention is described in detail by EXAMPLES, which by no means limit the present invention. The evaluation methods and resins used in EXAMPLES and COMPARATIVE EXAMPLES are described below.

1. Evaluation Method

(1) Melt flow rate (MFR): Determined in accordance with JIS K-6921-2: 1997 Appendix (230° C., 21.18 N load) for the propylene/α-olefin random copolymer, and with JIS K-6922-2: 1997 Appendix (190° C., 21.18 N load) for polyethylene, as described above.

(2) Tm: Determined by DSC, as described above.

(3) Mw/Mn: Determined by GPC, as described above.

(4) Mz/Mn: Determined by GPC, as described above.

(5) Density: Determined in accordance with JIS K-6922-2: 1997 Appendix (23° C.), as described above.

(6) HAZE: Determined in accordance with JIS K-7136-2000, as described above.

(7) Punching impact strength: Determined by a tester in accordance with JIS P-8134, where the tester is equipped with a metallic hemisphere (diameter: 25.4 Φmm) having a through-hole with mirror-glossy surface.

(8) Tearing strength: Determined in accordance with JIS K-7128 (1991) where the film was withdrawn in the MD direction.

(9) Heat-sealing strength: Two 15 mm wide films, laid one on top of another with the inner sides (the third layer) facing each other, were heat-sealed to each other on a hot plate type heat sealer (Toyo Seiki) under the conditions of sealing temperature: 100, 110 or 160° C., pressure: 0.2 MPa and sealing time: 1.0 second, and peel-off tested by a tensile tester at 500 mm/minute, to determine heat-sealing strength. The heat-sealing strength determined at 100 or 110° C. was taken as a measure of heat-sealing capacity at low temperature, and that determined at 160° C. as a measure of the highest film heat-sealing strength. The sample for determining heat-sealing strength determined at 160° C. was laminated with a 12 μm thick, biaxially drawn polyethylene terephthalate film by dry lamination, described later.

(10) Dry lamination: The multi-layered film of the present invention was corona-treated on the first layer side in such a way to have a wet tension of 42 mN/m. A 12 μm thick, commercial, biaxially drawn polyethylene terephthalate film, corona-treated on one side, was coated with an adhesive agent (mixture of AD-308, CAT-8B, both of Toyo Morton, and ethyl acetate (18/18/51 by mass) on the corona-treated side by gravure rolling to a thickness of 3 g sold/cm², and dried at 70° C. for 20 seconds. Then, these films were laid one on top of another with the corona-treated sides facing each other. The resulting laminate was treated at 40° C. for 24 hours to adjust the conditions.

2. Resins Used

(1) Component (A): Propylene/α-olefin random copolymer

The copolymers (PP-1 to PP-3) prepared in PRODUCTION EXAMPLES 1 to 3, and commercial propylene/α-olefin random copolymer (PP-4) were used. Their properties are given in Table 1.

### Production Example 1

(1) Catalyst Preparation

(i) Synthesis of racemic body of dimethylsilylenebis [2-methyl-4-(4-chlorophenyl)-4H-azulenyl] zirconium dichloride

It was prepared by the method disclosed by Example 12 of JP-A 10-226712.

(ii) Chemical Treatment of Ion-Exchangeable Silicate of Layered Structure

First, 200 g of chemically treated montmorillonite as the ion-exchangeable silicate of layered structure, prepared by the method disclosed by Example of JP-A 11-80229, was put in a 3 L glass reactor equipped with a stirring blade, to which 750 mL of normal heptane and then a heptane solution of tri normal octyl aluminum (500 mmols) were added. The mixture was stirred at room temperature for 1 hour, washed with normal heptane to a residual liquid rate below 1%, to prepare 2000 mL of the slurry.

(iii) Catalyst Preparation/Preliminary Polymerization

Next, a mixture of 870 mL of toluene slurry containing 3 mmols of (r) -dimethylsilylenebis [2-methyl-4-(4-chlorophenyl)-4H-azulenyl)] zirconium dichloride and 42.6 mL of heptane solution containing 15 mmols of triusobutyl aluminum, which were reacted with each other beforehand for 1 hour at room temperature, was added to the chemically treated montmorillonite described above, and the resulting mixture was stirred for 1 hour.

Then, 2.1 L of normal heptane was put in an autoclave (inner volume: 10 L) equipped with a stirrer, which was sufficiently purged with nitrogen beforehand, and kept at 40° C., to which the montmorillonite/complex slurry prepared above was added. Then, the mixture was incorporated, after it was stably kept at 40° C., with propylene at a rate of 100 g/hour for 4 hours while temperature was kept at the same level. It was kept at the same level for 2 hours after supply of propylene was stopped. The resulting preliminarily polymerized catalyst slurry was recovered, treated to remove about 3 L of the supernatant liquor, incorporated with 170 mL of heptane solution containing 30 mmols of triusobutyl aluminum, stirred for 10 minutes, and heat-treated at 40° C. under a vacuum. This produced the preliminarily polymerized catalyst containing 2.08 g of polypropylene per 1 g of the catalyst.

(2) Production of Propylene/ethylene Random Copolymer

A propylene/ethylene random copolymer was continuously produced by a process including a liquid-phase polymerization tank (inner volume: 270 L) equipped with a stirrer; passivation system comprising a passivation tank (inner volume: 400 L), slurry recycling pump and recycling line; high-pressure degassing system comprising a double-tube heat exchanger and fluidized flash tank; and post-treatment system comprising low-pressure degassing tank and drier.

The preliminarily polymerized catalyst was dispersed in liquid paraffin (Tonen, Whitelex 335) to 15% by mass, and charged to the liquid-phase polymerization tank at 0.52 g/hour as the catalyst component. The tank was also charged with liquefied propylene at 38 kg/hour, ethylene at 1.38 kg/hour, hydrogen at 0.20 g/hour and triisbutyl aluminum at 9.0 g/hour continuously for polymerization while the tank inside was kept at 62° C.

The mixed slurry of polymer and liquefied propylene was transferred from the liquid-phase polymerization tank to the passivation tank at 11 kg/hour as the polymer, where the catalyst was held in the polymerization tank for 1.3 hours as average residence time. The passivation tank was supplied with ethanol as a passivator at 10.5 g/hour. The polymer was transferred from the recycling line to the high-pressure degassing tank and then to the low-pressure degassing tank. Then, it was dried by the drier under the conditions set at 80° C. as drier inside temperature and residence time of 1 hour. Moreover, dried nitrogen was charged at 12 m³/hour countercurrently with the powder flow. The dried polymer (PP-1) was recovered from the hopper.

The resulting polymer (PP-1) contained ethylene at 3.3% by mass, and had an MFR of 7 g/10 minutes, Tm of 125° C. and Mw/Mn ratio of 2.8.

### Production Example 2

The polymer (PP-2) was prepared in the same manner as in PRODUCTION EXAMPLE 1, except that ethylene and hydrogen were charged at 0.77 kg/hour and 0.10 g/hour, respectively, and the tank inside was kept at 70° C. in the step (iv). It contained ethylene at 2.0% by mass, and had an MFR of 7 g/10 minutes, Tm of 135° C. and Mw/Mn ratio of 2.8.

### Production Example 3

(1) Catalyst Preparation and Preliminary Polymerization

A flask, sufficiently purged with nitrogen, was charged with 200 mL of n-heptane treated beforehand to remove moisture and oxygen, and then with 0.4 mols of MgCl₂ and 0.8 mols of Ti(O—n—C₄H₉)₄. The reaction was allowed to proceed for 2 hours while temperature was kept at 95° C. On completion of the reaction, the system was cooled to 40° C., to which 48 mL of methyl hydrogen polysiloxane (20 centistokes) was added, and the reaction was allowed to proceed for 3 hours. The resulting solid component was washed with n-heptane.

Then, a flask sufficiently purged with nitrogen was charged with 50 mL of n-heptane, and then with 0.24 mols as Mg of the solid component prepared above. The resulting mixture was incorporated with 25 mL of n-heptane and 0.4 mols of SiCl₄, and put in a flask over 60 minutes while temperature was kept at 30° C. The reaction was allowed to proceed at 90° C. for 3 hours.

Then, a mixture of 25 mL of n-heptane and 0.016 mols of phthalic acid chloride was put in the flask over 30 minutes while temperature was kept at 90° C., and the reaction was allowed to proceed for 1 hour at the same temperature level.

On completion of the reaction, the product was washed with n-heptane, and then reacted with 0.24 mmols of SiCl₄ for 3 hours at 100° C. On completion of the reaction, the product was again washed with n-heptane. A flask sufficiently purged with nitrogen was charged with 50 mL of sufficiently refined n-heptane and then with 5 g of the solid component prepared above. The resulting mixture was brought into contact with 0.81 mL of (CH₃)CSi(CH₃)(OCH₃)₂ for 2 hours at 30° C. Then, the product was washed with n-heptane, and the preliminary polymerization was carried out in a flow of propylene to prepare the solid catalyst.

(2) Production of Propylene/ethylenelbutane Random Copolymer

An autoclave (inner volume: 200 L) equipped with a stirrer, sufficiently purged with nitrogen beforehand, was charged with 60 L of refined n-heptane, and then with 15 g of triethyl aluminum and 1.8 g of the solid catalyst described above (as the weight free of the preliminarily prepared polymer) in a propylene atmosphere while temperature was kept at 55° C. Then, the autoclave was charged with propylene at 5.8 kg/hour while hydrogen concentration in the vapor phase was kept at 6.0% by volume, then with ethylene at 155 g/hour, and with 1-butene at 570 g/hour for 270 minutes after the polymerization was initiated. The polymerization was carried out for 6 hours. The polymerization was continued further for 1 hour after supply of all of the monomers was stopped, and terminated with butanol. The product was filtered and dried. The resulting propylene/ethylene/1-butane random copolymer (PP-3) had an MFR of 8 g/10 minutes, Tm of 132° C. and Mw/Mn ratio of 3.9, and contained ethylene and butane at 2.5 and 8.5% by mass, respectively.

TABLE 1

| | Polymer- | MFR | | | |
|---|---|---|---|---|---|
| | ization | (g/10 | Tm | Mw/Mn | |
| Resin | catalyst | minutes) | (° C.) | (—) | Name |
| PP-1 | Metallocene | 7 | 125 | 2.8 | Copolymer prepared in |
| | | | | | PRODUCTION |
| | | | | | EXAMPLE 1 |
| PP-2 | Metallocene | 7 | 135 | 2.8 | Copolymer prepared in |
| | | | | | PRODUCTION |
| | | | | | EXAMPLE 2 |
| PP-3 | Ziegler | 8 | 132 | 3.9 | Copolymer prepared in |
| | | | | | PRODUCTION |
| | | | | | EXAMPLE 3 |
| PP-4 | Metallocene | 7 | 142 | 2.8 | Japan Polypropylene, |
| | | | | | WINTEC WMB 3 |

(2) Ethylene/α-olefin Copolymer as Component (B)

The ethylene/α-olefin copolymers PE-1 to PE-5 prepared in PRODUCTION EXAMPLES 4 to 8, described below, and the commercial ethylene/α-olefin copolymers PE-6 and PE-7 prepared in the presence of a Ziegler catalyst were used. Their properties are given in Table 2.

### Production Example 4

An ethylene/1-hexene copolymer was prepared. The polymerization catalyst was prepared in accordance with the procedure described in PA-J 7-508545, where a mixture of 2.0 mmols of a complex of dimethylsilylenebis(4,5,6,7-tetrahydroindenyl) hafnium dimethyl and equimolar trispentafluorophenyl boron was diluted to 10 L with toluene, to prepare a catalyst solution.

A continuous autoclave reactor (inner volume: 1.5 L) equipped with a stirrer was charged with a mixed composition of ethylene and 1-hexene (hexene: 62% by weight), and the reaction was allowed to proceed at 130 MPa and 140° C. The polymer yield was around 2.0 kg in one hour.

This produced the ethylene/α-olefin copolymer (PE-1) which contained 1-hexene at 15% by mass, and had an MFR of 2.2 g/10 minutes, density of 0.898 g/cm³ and Mz/Mn ratio of 3.5.

### Production Example 5

An ethylene/1-hexene copolymer was prepared in the same manner as in PRODUCTION EXAMPLE 4, except that the mixed composition contained 1-hexene at 55% by mass and polymerization temperature was set at 148° C. The polymerization catalyst was prepared also in the same manner. The polymer yield was around 2.1 kg in one hour.

This produced the ethylene/α-olefin copolymer (PE-2) which contained 1-hexene at 12% by mass, and had an MFR of 2.2 g/10 minutes, density of 0.905 g/cm³ and Mz/Mn ratio of 3.5.

### Production Example 6

An ethylene/1-hexene copolymer was prepared in the same manner as in PRODUCTION EXAMPLE 4, except that the mixed composition contained 1-hexene at 73% by mass and polymerization temperature was set at 127° C. The polymerization catalyst was prepared also in the same manner. The polymer yield was around 2.5 kg in one hour.

This produced the ethylene/α-olefin copolymer (PE-3) which contained 1-hexene at 24% by mass, and had an MFR of 3.5 g/10 minutes, density of 0.880 g/cm³ and Mz/Mn ratio of 3.4.

### Production Example 7

An ethylene/1-hexene copolymer was prepared in the same manner as in PRODUCTION EXAMPLE 4, except that the mixed composition contained 1-hexene at 65% by mass and polymerization temperature was set at 158° C. The polymerization catalyst was prepared also in the same manner. The polymer yield was around 3.7 kg in one hour.

This produced the ethylene/α-olefin copolymer (PE-4) which contained 1-hexene at 17% by mass, and had an MFR of 16.5 g/10 minutes, density of 0.898 g/cm³ and Mz/Mn ratio of 3.5.

### Production Example 8

An ethylene/1-hexene copolymer was prepared in the same manner as in PRODUCTION EXAMPLE 4, except that the mixed composition contained 1-hexene at 40% by mass and polymerization temperature was set at 170° C. The polymerization catalyst was prepared also in the same manner. The polymer yield was around 3.0 kg in one hour.

This produced the ethylene/α-olefin copolymer (PE-5) which contained 1-hexene at 7% by mass, and had an MFR of 4.0 g/10 minutes, density of 0.918 g/cm³ and Mz/Mn ratio of 3.8.

TABLE 2

| | Polymer- | MFR | | | | |
|---|---|---|---|---|---|---|
| | ization | (g/10 | Density | a-olefin content | Mz/Mn | |
| Resin | catalyst | minutes) | (g/cm³) | (wt %) | (—) | Name |
| PE-1 | Metallocene | 2.2 | 0.898 | 15 | 3.5 | Copolymer prepared |
| | | | | | | in PRODUCTION |
| | | | | | | EXAMPLE 4 |
| PE-2 | Metallocene | 2.2 | 0.905 | 12 | 3.5 | Copolymer prepared |
| | | | | | | in PRODUCTION |
| | | | | | | EXAMPLE 5 |
| PE-3 | Metallocene | 3.5 | 0.880 | 24 | 3.4 | Copolymer prepared |
| | | | | | | in PRODUCTION |
| | | | | | | EXAMPLE 6 |
| PE-4 | Metallocene | 16.5 | 0.898 | 17 | 3.5 | Copolymer prepared |
| | | | | | | in PRODUCTION |
| | | | | | | EXAMPLE 7 |
| PE-5 | Metallocene | 4 | 0.918 | 7 | 3.8 | Copolymer prepared |
| | | | | | | in PRODUCTION |
| | | | | | | EXAMPLE 8 |
| PE-6 | Ziegler | 2 | 0.935 | — | — | Japan Polychem |
| | | | | | | NOVATEC SF941 |
| PE-7 | Ziegler | 2 | 0.915 | — | — | Mitsui Chemicals |
| | | | | | | ULTZEX 1520L |

(3) Component (C)

High-density polyethylene (Japan Polychem, NOVATEC HJ580), MFR: 12 g/10 minutes, Density: 0.960 g/cm³

### Example 1

PP-1 as Component (A) for the propylene-based resin layer and PE-1 as Component (B) for the ethylene-based resin layer were each molten and extruded through an annular die (diameter: 80 mm, lip width: 1 mm) set in an extruder (bore diameter: 50 mm) under the conditions of blow ratio: 2 and discharge rate 40 m/minute, to prepare a 30 μm thick, 3-layered film by air-cooled inflation molding, where the first layer served as the external layer and third layer as the inner layer. The film properties are given in Table 3.

### Example 2

A 3-layered film was prepared in the same manner as in EXAMPLE 1, except that a composition composed of 1 part by mass of Component (C) incorporated in 100 parts by mass of PP-1 as Component (A) for the propylene-based resin layer was used. The film properties are given in Table 3.

### Example 3

A 3-layered film was prepared in the same manner as in EXAMPLE 2, except that PE-7 (Mitsui Chemicals, ULTZEX 15201) as Component (B) for the ethylene-based resin layer was used. The film properties are given in Table 3.

### Example 4

A 3-layered film was prepared in the same manner as in EXAMPLE 2, except that the thickness ratio was changed, as given in Table 3. The film properties are given in Table 3.

### Example 5

A 3-layered film was prepared in the same manner as in EXAMPLE 2, except that the thickness ratio was changed, as given in Table 3. The film properties are given in Table 3.

### Example 6

A 3-layered film was prepared in the same manner as in EXAMPLE 2, except that one of the ethylene-based resin layer was changed to that of PE-5. The film properties are given in Table 3.

### Example 7

A 3-layered film was prepared in the same manner as in EXAMPLE 2, except that PE-3 was used for the ethylene-based resin layer. The film properties are given in Table 3.

### Example 8

A 3-layered film was prepared in the same manner as in EXAMPLE 2, except that PE-5 was used for the ethylene-based resin layer. The film properties are given in Table 3.

### Example 9

A 3-layered film was prepared in the same manner as in EXAMPLE 2, except that PE-2 was used for the ethylene-based resin layer. The film properties are given in Table 3.

### Example 10

A 3-layered film was prepared in the same manner as in EXAMPLE 1, except that a composition composed of 5 parts by mass of high-density polyethylene as Component (C) incorporated in 100 parts by mass of PP-2 as Component (A) for the propylene-based resin layer was used. The film properties are given in Table 3.

### Comparative Example 1

A 3-layered film was prepared in the same manner as in EXAMPLE 1, except that PE-6 (Japan Polychem, NOVATEC SF941) was used for the ethylene-based resin layer. The film properties are given in Table 3.

### Comparative Example 2

A 3-layered film was prepared in the same manner as in EXAMPLE 1, except that PP-3 was used for the propylene-based resin layer. The film properties are given in Table 3.

TABLE 3

| | | | | EXAMPLE | | | | | | | | | |
|---|---|---|---|---|---|---|---|---|---|---|---|---|---|
| | | | | 1 | 2 | 3 | 4 | 5 | 6 | 7 | 8 | 9 | 10 |
| Resin | First layer | | | PE-1 | PE-1 | PE-7 | PE-1 | PE-1 | PE-5 | PE-3 | PE-5 | PE-2 | PE-1 |
| | Second layer | | | PP-1 | BL-1*¹ | BL-1*¹ | BL-1*¹ | BL-1*¹ | BL-1*¹ | BL-1*¹ | BL-1*¹ | BL-1*¹ | BL-2*² |
| | Third layer | | | PE-1 | PE-1 | PE-7 | PE-1 | PE-1 | PE-1 | PE-3 | PE-5 | PE-2 | PE-1 |
| Film | Thickness | total layer | μm | 30 | 30 | 30 | 30 | 80 | 30 | 30 | 30 | 30 | 30 |
| properties | | First layer | μm | 12 | 12 | 12 | 6 | 32 | 12 | 12 | 12 | 12 | 12 |
| | | Second layer | μm | 6 | 6 | 6 | 18 | 16 | 6 | 6 | 6 | 6 | 6 |
| | | Third layer | μm | 12 | 12 | 12 | 6 | 32 | 12 | 12 | 12 | 12 | 12 |
| | | Second layer/ | % | 20 | 20 | 20 | 60 | 20 | 20 | 20 | 20 | 20 | 20 |
| | | total layer | | | | | | | | | | | |
| | HAZE | | % | 1.8 | 1.8 | 3 | 1.8 | 2.4 | 2.6 | 1.8 | 2 | 2.1 | 1.9 |
| | Punching impact | | kgcm/cm | 1560 | 1560 | 1300 | 1450 | 1400 | 1470 | 1500 | 1350 | 1770 | 1490 |
| | strength | | | | | | | | | | | | |
| | Tearing | MD | N/mm | 55 | 55 | 50 | 45 | 58 | 58 | 42 | 90 | 63 | 55 |
| | strength | TD | N/mm | 200 | 200 | 180 | 180 | 210 | 210 | 160 | 180 | 200 | 200 |
| | Heat- | 100° C. | g/15 mm | 400 | 400 | 0 | 400 | 200 | 400 | 650 | 420 | 200 | 400 |
| | sealing | 110° C. | g/15 mm | 600 | 600 | 150 | 800 | 600 | 800 | 750 | 620 | 590 | 600 |
| | capacity*³ | 160° C.*⁴ | g/15 mm | 4200 | 4250 | 4200 | 4350 | 4500 | 4200 | 4200 | 4300 | 4300 | 4200 |

*¹BL-1: Mixture of PP-1 (100 parts by mass)/HDPE (1 part by mass)
*²BL-2: Mixture of PP-1 (100 parts by mass)/HDPE (5 parts by mass)
*³the inner sides (the third layer) facing each other were heat-sealed to each other
*⁴laminated with a 12 mm thick, biaxially drawn PET film by dry lamination (the first layer), after that, the inner sides (the third layer) facing each other were heat-sealed to each other

TABLE 4

| | | | | COMPARATIVE | |
|---|---|---|---|---|---|
| | | | | EXAMPLE | |
| | | | | 1 | 2 |
| Resin | First layer | | | PE-6 | PE-1 |
| | Second layer | | | PP-1 | PP-3 |
| | Third layer | | | PE-6 | PE-1 |
| Film | Thickness | total layer | μm | 30 | 30 |
| properties | | First layer | μm | 12 | 12 |
| | | Second layer | μm | 6 | 6 |
| | | Third layer | μm | 12 | 12 |
| | | Second layer/ | % | 20 | 20 |
| | | total layer | | | |
| | HAZE | | % | 7.2 | 7 |
| | Punching impact | | kgcm/cm | 1100 | 1500 |
| | strength | | | | |
| | Tearing | MD | N/mm | 58 | 55 |
| | strength | TD | N/mm | 210 | 190 |
| | Heat- | 100° C. | g/15 mm | 0 | 400 |
| | sealing | 110° C. | g/15 mm | 0 | 600 |
| | capacity*¹ | 160° C.*² | g/15 mm | 1450 | 1550 |

*¹the inner sides (the third layer) facing each other were heat-sealed to each other
*²laminated with a 12 mm thick, biaxially drawn PET film by dry lamination (the first layer), after that the inner sides (the third layer) facing each other were heat-sealed to each other

### Example 11

PP-1 as Component (A) for the propylene-based resin layer (second layer) was charged to a 35 mmΦ extruder of a T-die molder (PLACO) for producing a multi-layered film composed of 3 different layers, equipped with a 20 mmΦ, 35 mmΦ and 20 mmΦ extruders, and a mixed resin composition of PE-5 as Component (B) incorporated with MB-1 (Japan Polyethylene, anti-blocking agent, slip agent master batch, Kernel KMB243) at 2 parts by mass per 100 parts by mass of PE-5 for the first and third layers holding the second layer in-between was charged to 2 extruders (20 mmΦ). They were molten and extruded at 220° C. through a 300 mm wide T-die, and then wound around a 300 mm chill roll kept at 40° C. for cooling/solidification to produce the 60 μm thick cast film at a rate of 10 m/minute. The first, second and third layers of the resulting multi-layered film were controlled to be in a thickness ratio of 1/4/1, where the first and third layers faced an air knife and chill roll, respectively. The film properties are given in Table 5.

### Example 12

A 3-layered film was prepared in the same manner as in EXAMPLE 11, except that PP-4 (Japan Polypropylene, WINTEC WMB 3) was used as Component (A) for the propylene-based resin layer. The film properties are given in Table 5.

### Comparative Example 3

A 3-layered film was prepared in the same manner as in EXAMPLE 11, except that PP-3 was used as Component (A) for the propylene-based resin layer. The film properties are given in Table 5.

TABLE 5

| | | | | | | COMPARATIVE |
|---|---|---|---|---|---|---|
| | | | | EXAMPLE | | EXAMPLE |
| | | | | 11 | 12 | 3 |
| Resin | First layer | | | PE-5*¹ | PE-5*¹ | PE-5*¹ |
| | Second layer | | | PP-1 | PP-4 | PP-3 |
| | Third layer | | | PE-5*¹ | PE-5*¹ | PE-5*¹ |
| Film | Thickness | total layer | μm | 60 | 60 | 60 |
| properties | | First layer | μm | 10 | 10 | 10 |
| | | Second layer | μm | 40 | 40 | 40 |
| | | Third layer | μm | 10 | 10 | 10 |
| | | Second layer/ | % | 67 | 67 | 67 |
| | | total layer | | | | |
| | HAZE | | % | 4 | 4.5 | 6 |
| | Heat-sealing | 100° C. | g/15 mm | 400 | 400 | 400 |
| | capacity*² | 110° C. | g/15 mm | 600 | 600 | 600 |
| | | 160° C.*³ | g/15 mm | 4500 | 4450 | 1350 |

*¹Mixture of PE-5(100 parts by mass)/MB-1 (2parts by mass)
*²the inner sides (the third layer) facing each other were heat-sealed to each other
*³laminated with a 12 mm thick, biaxially drawn PET film by dry lamination (the first layer), after that the inner sides (the third layer) facing each other were heat-sealed to each other

The multi-layered film of the present invention is excellent in transparency, tearing strength, impact strength, heat-sealing capacity at low temperature and interlayer strength; high in product value as a packing material; and suitable for packing foods, clothing, medicines, utensils and miscellaneous goods, among others.

1. A multi-layered film comprising a propylene-based resin layer composed of Component (A) described below as the major component, laminated on each side with an ethylene-based resin layer composed of Component (B) described below:
Component (A): propylene/α-olefin random copolymer, produced in the presence of a metallocene catalyst and having the following characteristics (A1) to (A3),
(A1) melt flow rate (MFR, determined at 230° C. and 21.18 N load): 1 to 30 g/10 minutes,
(A2) melting peak temperature (Tm), determined by differential scanning calorimetry (DSC): 110 to 165° C., and
(A3) weight-average molecular weight (Mw)/number-average molecular weight (Mn) ratio (Mw/Mn ratio), determined by gel permeation chromatography (GPC): 1.5 to 3.5,
Component (B): copolymer of ethylene and α-olefin of 3 to 12 carbon atoms, having the following characteristics (B1) and (B2):
(B1) melt flow rate (MFR, determined at 190° C. and 21.18 N load): 0.1 to 20 g/10 minutes, and
(B2) density: 0.860 to 0.925 g/cm³.

2. The multi-layered film according to claim 1, wherein the copolymer of ethylene and α-olefin of 3 to 12 carbon atoms as Component (B) is produced in the presence of a metallocene catalyst and has the following characteristics (B3) and (B4):
(B3) α-olefin content: 5 to 40% by mass, and
(B4) Z-average molecular weight (Mz)/number-average molecular weight ratio (Mz/Mn ratio), determined by gel permeation chromatography (GPC): 8.0 or less.

3. The multi-layered film according to claim 1 which has a tearing strength of 20 N/mm or more and punching impact strength of 1000 kg·cm/cm or more.

4. The multi-layered film according to claim 1, wherein the propylene-based resin layer is incorporated with Component (C) described below at 0.1 to 5 parts by mass per 100 parts by mass of Component (A):
Component (C): high-density polyethylene having the following characteristics (C1) and (C2):
(C1) melt flow rate (MFR, determined at 190° C. and 21.18 N load): 10 g/10 minutes or more, and
(C2) density: 0.94 to 0.98 g/cm³.

5. The multi-layered film according to claim 1, wherein thickness of the propylene-based resin film is 20 to 90% of thickness of the whole multi-layered film.

6. The multi-layered film according to claim 1, wherein thickness of the whole multi-layered film is 10 to 150 μm.

7. A multi-layered film produced by air-cooled inflation molding and comprising a propylene-based resin layer composed of Component (A) described below as the major component, laminated on each side with an ethylene-based resin layer composed of Component (B) described below:
Component (A): propylene/α-olefin random copolymer, produced in the presence of a metallocene catalyst and having the following characteristics (A1) to (A3),
(A1) melt flow rate (MFR, determined at 230° C. and 21.18 N load): 1 to 20 g/10 minutes,
(A2) melting peak temperature (Tm), determined by differential scanning calorimetry (DSC): 110 to 135° C., and
(A3) weight-average molecular weight (Mw)/number-average molecular weight (Mn) ratio (Mw/Mn ratio), determined by gel permeation chromatography (GPC): 1.5 to 3.5,
Component (B): copolymer of ethylene and α-olefin of 3 to 12 carbon atoms, having the following characteristics (B1) and (B2):
(B1) melt flow rate (MFR, determined at 190° C. and 21.18 N load): 0.1 to 20 g/10 minutes, and
(B2) density: 0.860 to 0.925 g/cm³.

8. The multi-layered film according to claim 7, wherein the copolymer of ethylene and α-olefin of 3 to 12 carbon atoms as Component (B) is produced in the presence of a metallocene catalyst and has the following characteristics (B3) and (B4):
(B3) α-olefin content: 5 to 40% by mass, and
(B4) Z-average molecular weight (Mz)/number-average molecular weight Mn ratio (Mz/Mn ratio), determined by gel permeation chromatography (GPC): 8.0 or less.

9. The multi-layered film according to claim 7 which has a tearing strength of 20 N/mm or more and punching impact strength of 1000 kg·cm/cm or more.

10. The multi-layered film according to claim 7, wherein the propylene-based resin layer is incorporated with Component (C) described below at 0.1 to 5 parts by mass per 100 parts by mass of Component (A):
Component (C): high-density polyethylene having the following characteristics (C1) and (C2):
(C1) melt flow rate (MFR, determined at 190° C. and 21.18 N load): 10 g/10 minutes or more, and
(C2) density: 0.94 to 0.98 g/cm³.

11. The multi-layered film according to claim 7, wherein thickness of the propylene-based resin film is 20 to 90% of thickness of the whole multi-layered film.

12. The multi-layered film according to claim 7, wherein thickness of the whole multi-layered film is 10 to 150 μm.
